(19) United States
(12) Patent Application Publication
(10) Pub. No.: US 2007/0089285 A1
(43) Pub. Date: Apr. 26, 2007

(54) Method for manufacturing a structurally integrated antenna

(75) Inventors: Stefan Utecht, Kaufering (DE); Robert Sekora, Kirchseeon (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/583,027

(22) Filed: Oct. 19, 2006

(30) Foreign Application Priority Data
Oct. 20, 2005 (DE) 10 2005 050 204.0

(51) Int. Cl. H01P 11/00

(52) U.S. Cl. 29/600; 343/700 MS

(57) ABSTRACT

A method for manufacturing a structurally integrated antenna into a fiber composite carrier structure of a vehicle includes the following method steps: arranging an antenna preform on a carrier system primary structure which is the form of a fibrous semifinished product, whereby the antenna preform comprises one or more flexible conductive antenna elements arranged in a layer; and curing the component by means of a temperature and/or pressure treatment.

### BACKGROUND AND SUMMARY OF THE INVENTION

This application claims the priority of German patent document 10 2005 050 204.0, filed Oct. 20, 2005, the disclosure of which is expressly incorporated by reference herein.

The invention relates to a method for manufacturing a structurally integrated antenna in the fiber composite carrier structure of a motor vehicle. Such a structurally integrated antenna can be used in general for vehicles and for aircraft, such as airplanes, helicopters, dirigibles, drones, rockets or space vehicles.

Half-wave- or quarter-wave-long wire antennas as well as the designs derived therefrom or strut antennas having large frequency ranges (for example, from 2 MHz to 400 MHz) are known. However, these antennas exhibit aerodynamic problems, in particular in airplanes, and due to their dimensions (up to a few tens of meters), they can be installed only at great expense. Furthermore since only special installation sites are appropriate for these antennas on vehicles, large cable lengths are usually necessary for their installation, which increases the installation expense and complexity, and entails line losses, which further impairs the transmission quality. These problems are exacerbated by the fact that in modern aircraft, the number of avionic functions has grown progressively, and thus the required number of antennas has also increased, so that an order of magnitude of sixty antenna systems may be used.

It is known from the general state of the art that such antennas may be fundamentally integrated structurally into carrier structures of vehicles or aircraft. EP 1 538 698 A1, for example, describes an antenna arranged in a carrier structure of a vehicle such that it has external structural conformity. The antenna is embedded in the form of an antenna function core in a well of a carrier system primary structure made of a fiber composite material in a form-fitting or frictional connection. When using the antenna function core in the carrier system primary structure, the carrier system primary structure is already present in the form of a completely hardened fiber-reinforced plastic material. The antenna function core also includes a hard rigid substrate for the antenna elements. This design is associated with great restrictions with regard to surface shaping. Large antenna structures in particular, typically more than 0.1 m can be implemented in this way only with great restrictions.

However, these types of antennas allow the use of frequency ranges above 1.0 GHz, which leads to a small and compact design of the elementary emitters. Only by combining these elementary emitters into group antennas is a greater extent necessary, i.e., up to 50 times the wavelength used.

A publication by Robert Sekora entitled “Conformal Airborne Array Antenna for Broad Band Data Link Applications in the X-Band” describes the essential differences between traditional and more recent antenna systems having external structural conformity, i.e., adapting closely to the structure—in this case that of aircraft.

Another article by Robert Sekora, “Structurally Integrated Aircraft Antenna for Broad Band Applications in the X-Band”, explains the structural integrability of an array antenna. Furthermore, the structural design is confirmed with regard to its electromagnetic function.

These known antenna designs, however, are not suitable for use as elementary emitters which are installed only individually or in pairs assigned to component structures such as aircraft structures, because they pose special requirements with regard to integration due to their absolute size. One such requirement is that the area with the antenna integrated in the structure must be designed for predetermined mechanical loads. From an electronic standpoint, suitable materials must be provided for the antennas, whereby the mechanical strength and stability of the structure must not be impaired.

One object of the present invention is to provide a structurally integrated antenna as well as a method of manufacturing such a structurally integrated antenna, in which the mechanical strength and load-bearing capacity of the carrier system primary structure as well as its external form are not impaired due to the installation of the antenna.

This and other objects and advantages are achieved by the method and apparatus according to the invention, in which the antenna that is to be integrated into the carrier structure of a vehicle is so integrated already during the manufacture of the carrier structure, and forms an inseparable component of this structure. For this purpose, an antenna preform is arranged on a carrier system primary structure in the form of a fibrous semifinished product (dry or preimpregnated). The antenna blank comprises one or more flexible conductive elements (hereinafter also referred to as antenna elements) arranged in a layer. The antenna elements are preferably in the form of a metal strip, a wire or a wire mesh (e.g., in the manner of stranded wire). With the method according to the invention, any three-dimensional shapes of the antenna structure are possible due to the flexibility of the antenna elements. Then the component is hardened by a temperature and/or pressure treatment (including vacuum conditions), e.g., in an autoclave or a circulating air oven.

Unlike the arrangement in EP 1 538 698 A1, the present invention thus relates not only to an antenna having external structural conformity but also a structurally integrated antenna. In particular no fibers of the carrier system primary structure are interrupted by the antenna elements. No immobile substrates for the conductive elements are needed.

The antenna produced according to this invention offers significant savings in terms of weight and volume in comparison with conventional antenna constructions, and is thus advantageous for aircraft in particular. In use of the antenna produced according to this invention, the shape of the outer membrane of the structures can remain unchanged due to the use of the flexible bendable antenna elements, allowing optimal use of the antenna from an aerodynamic standpoint.

At the installation site of the antenna, the mechanical properties of the carrier structure are not impaired, so the antenna may be installed in various locations in the vehicle structure to achieve optimum installation sites with regard to the emission properties (i.e., with regard to the electronic and electromagnetic properties of the antennas).

From an electronic standpoint, the structural integration of the antenna according to the invention offers substantial potential for reducing the radar signature in comparison with traditional antennas.

The flexible conductive elements of the antenna which are arranged in a layer (referred to below as the antenna layer) are formed from a suitable conductive metallic material. Suitable materials include copper, brass, aluminum, silver, gold, tin and alloys produced and/or derived therefrom. The antenna layer may also contain components of dielectric materials (e.g., quartz glass, ceramic composite materials, PTFE). The conductive elements may be formed from a wire or a highly flexible electrically conducting strand and in particular a copper strand. The strand arrangement may be in the form of a braided structure or a flat strip-like bundle. Alternatively, the metallic elements of the antenna layer may also consist of one or more metal strips. However, films or molded parts punched from films are also possible.

The material of the carrier system primary structure is in the form of a dry or preimpregnated semifinished product (prepreg) containing fibers. Fibers that may be used include in particular carbon fibers (CRP), fiberglass (FRP), aramid fibers (ARP), boron fibers (BRP), ceramic fibers or silicon fibers.

The antenna preform may, in its simplest embodiment, consist of the antenna layer itself. If, in the case of a conductive carrier system primary structure, (e.g., when using carbon fibers), an insulation layer is needed as an intermediate layer between the carrier system primary structure and the antenna layer, then the antenna preform may comprise such an insulation layer. However, it is also possible to apply the insulation layer first to the carrier system primary structure and only then apply it to the antenna preform.

In addition, the antenna blank may also comprise, in addition to the antenna layer and/or the insulation layer, a nonconducting top layer forming the outer closure of the structure. However, the nonconducting top layer may also be applied to the antenna blank in a separate operation after the blank has already been applied to the carrier system primary structure. The top layer is only optional because its requirement depends on the specific application.

Fiberglass materials (e.g., in the form of glass cloth), may preferably be used as the materials for the top layer and the intermediate layer. A multiaxial nonwoven may be used to particular advantage.

The top layer and insulation layer as well as the conductive antenna element(s) are advantageously coordinated in such a way that they have essentially the same shape and size, so that complete coverage of the conductive elements is possible. The dimensions of the top layer and insulation layer are advantageously somewhat larger than the dimensions of the antenna elements to achieve a secure coverage and/or insulation.

As already mentioned, the carrier system primary structure, the intermediate layer and the top layer may be in the form of a dry fibrous semifinished product or in the form of a so-called prepreg (fiber material preimpregnated with a resin). When using prepregs, the adhesion of the layers to be bonded is already ensured by the resin of the prepregs, and no additional bonding techniques need be used. Furthermore, no additional infiltration of the component is necessary when using prepregs. As soon as the layer structure is complete, it is simply cured under an elevated temperature, with or without applying an excess pressure or under vacuum conditions in an autoclave or a circulating air oven.

If the materials for carrier system primary structure, intermediate layer and top layer are in the form of a dry fibrous semifinished product, however, care must be taken in joining the individual layers. Adhesive techniques (also in conjunction with heat input—i.e., pressing the layers to be bonded) as well as sewing and knitting techniques may be used for the fixation and joining of the individual layers to one another and/or to the carrier system primary structure. The antenna preform is especially advantageously sewn or knitted onto the carrier system primary structure. If an insulation layer is required, the conductive elements of the antenna layer may be knit or sewn directly onto the (dry) insulation layer. Then the antenna preform produced in this way is sewn and/or knitted onto the carrier system primary structure.

Thermoplastic intermediate layers may be used for the bonding, for example. These fixation layers may be formed by a thermoplastic film or a thermoplastic nonwoven, a copolyamide, in particular Crylon or some other thermoplastic bond. For bonding, a spray adhesive or a powder bonder or resin films may be used, so the fixation layers may also be formed from resin.

In the case of dry starting materials, after gluing and/or sewing or knitting, the component is impregnated with a suitable resin. In particular an injection method (e.g., according to DE 100 13 409 C1 or DE 101 40 166 A1) is suitable for this purpose. Then the part is cured under an elevated temperature. This may be accomplished with or without applying an excess pressure in an autoclave or a circulating air oven.

With the inventive method, it is possible to manufacture any structures, including those that have a three-dimensional curvature and can be rolled up or not rolled up or not completely rolled up.

Other objects, advantages and novel features of the present invention will become apparent from the following detailed description of the invention when considered in conjunction with the accompanying drawings.

### BRIEF DESCRIPTION OF THE DRAWINGS

FIG. 1 shows production of an antenna according to the invention, by knitting or sewing techniques;

FIG. 2 shows production with prepregs as the starting material for the individual layers;

FIG. 3 shows production with dry fiber semifinished product as the starting material for the individual layers;

FIG. 4 shows the layer structure according to FIG. 3;

FIG. 5 shows production with dry fiber semifinished product as the starting material but without the insulation layer and top layer.

### DETAILED DESCRIPTION OF THE DRAWINGS

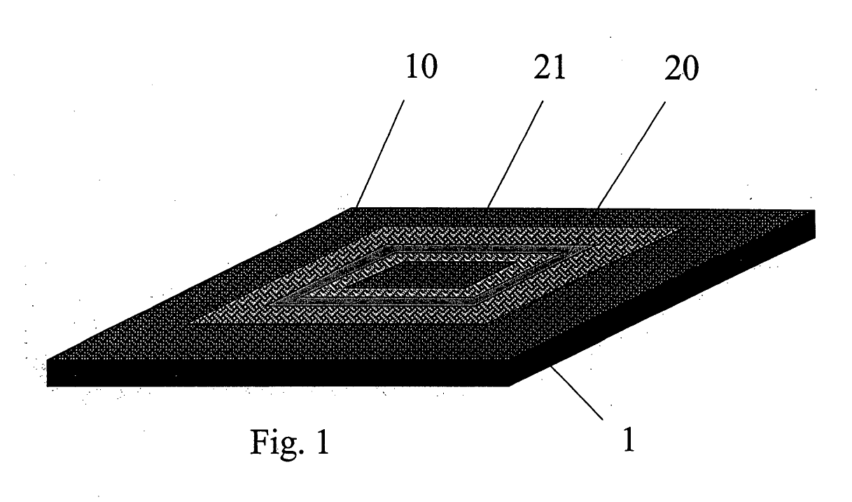

FIG. 1 shows a first embodiment of the method according to the invention, using knitting or sewing techniques. The carrier system primary structure 10 in the form of a dry fiber semifinished product (e.g., carbon or glass fibers) is clamped in a tenter frame 1. The single conductive antenna element 20 arranged in a layer is here comprises a metallic strand (e.g., copper, silver, gold, bronze) in the form of a rectangular loop. The antenna element 20 is knit or sewn by CNC-controlled knitting/sewing head on the carrier system primary structure. Due to the repeat precision of the CNC-controlled system, the positionability of overlapping layers is ensured in particular. Due to the use of a robot-guided system, three-dimensionally curved structures that cannot be rolled up can also be produced.

If the material of the carrier system primary structure is electric conductive (e.g., when using carbon fibers), then an insulation layer 21 must be provided between the antenna element 20 and the carrier system primary structure 10. In this case in a separate operation the antenna element 20 may first be sewn or knitted onto a closed insulation layer. Then the protruding areas of the insulation layer (not yet covered by the antenna element 20) are removed while maintaining a safety margin so that the antenna element 20 and cut insulation layer 21 have essentially the same shape and (except for the safety margin) essentially the same dimensions. The loop-shaped antenna preform produced in this way is then knitted or sewn onto the carrier system primary structure 10.

In both method variants, the component is impregnated with a suitable resin after producing the desired layer structure. Then the component is cured by a heat treatment which can be performed with or without applying an excess pressure or under vacuum conditions.

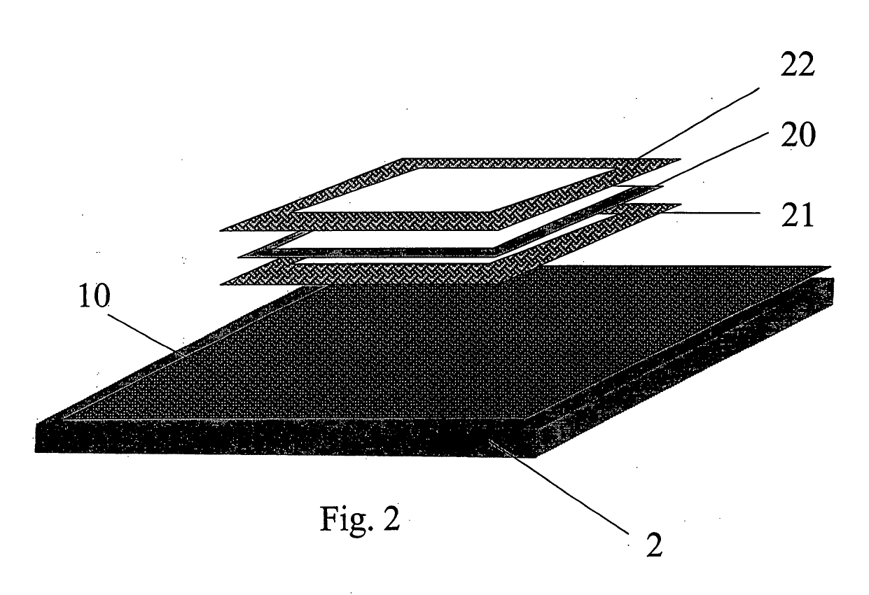

FIG. 2 shows as another embodiment of the production of the component according to the invention, using preimpregnated prepregs as the starting material for the individual layers (carrier system primary structure 10, insulation layer 21, top layer 22). The carrier system primary structure 10 is inserted into a curing device. The layer structure is created by means of a hand-laying method of creating the individual layers or by means of a CNC-controlled laying head. The conductive antenna element 20 arranged in a layer comprises a metallic strand (e.g., copper, silver, gold, bronze) in the form of a rectangular loop as shown in FIG. 1. The insulation layer 21 may be laid on the carrier system primary structure 10 without any further adhesive layer because the resin of the prepregs mediates the adhesion between the layers. Then the antenna element 20 is placed on the insulation layer 21 and the top layer 22 is placed on the antenna element 20, each without any additional adhesive layer.

According to another embodiment of the invention, a sandwich of a top layer 22, insulation layer 21 and antenna element 20 in between is first formed in a separate method step to produce an antenna preform. The antenna preform is then applied to the carrier system primary structure 10. The bonding is accomplished without additional bonding layers. In both method variants, after producing the desired layer structure, the component is cured by means of a heat treatment which can be performed with or without applying excess pressure or under vacuum conditions.

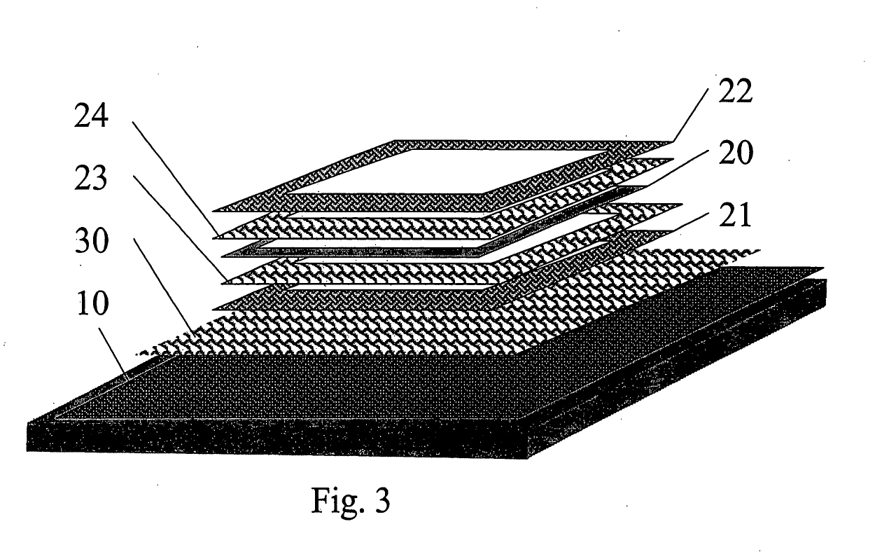

FIG. 3 shows another embodiment of the invention for producing the component with dry fiber semifinished product, from starting material for the individual layers, namely carrier system primary structure 10 (e.g., carbon fibers), insulation layer 21 (e.g., glass fibers), top layer 22 (e.g., glass fibers). The individual layers are placed one above the other, with fixation layers 23, 24, 30, for example a thermoplastic material inserted between the individual layers 10, 20, 21, 22, (20 also refers to the antenna element in FIG. 3). If a film or a nonwoven is used as the fixation layer, then the fixation layer is placed between the layers to be joined. When using adhesives or binders, they are preferably applied to one or both surfaces that are to be joined.

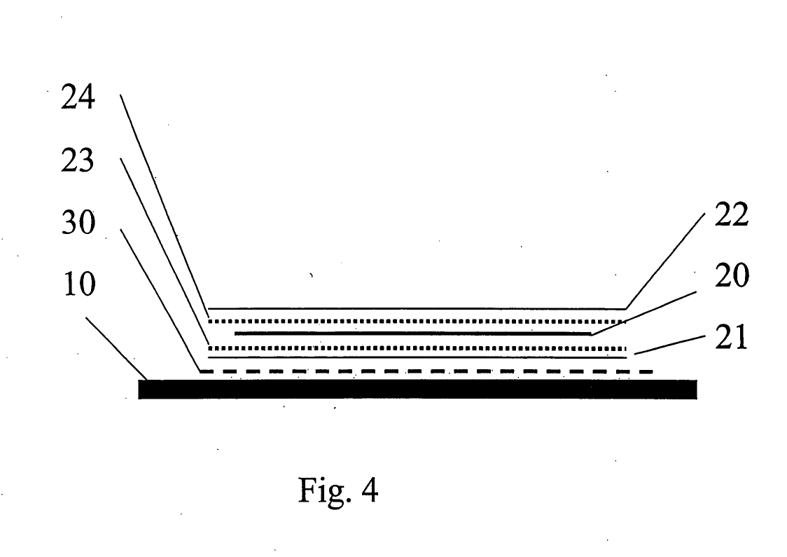

FIG. 4 shows the details of the layer structure.

In a method step of an alternative method, an antenna sample is formed from a top layer 22, antenna element 20 and insulation layer 21. These layers are at first in the form of dry fiber semifinished product. The antenna sample may be formed in a resin injection method or a resin film process, for example. Then the antenna preform thus produced is laid on the carrier system primary structure 10 with a fixation layer 30 in between and thus fixed in that position. The same materials and techniques as those used above with respect to the fixation layers of the embodiment described above may also be used for the fixation layer here. Then the component is impregnated with resin in another method step and subsequently cured. The two method steps may be performed in a circulating air oven or an autoclave.

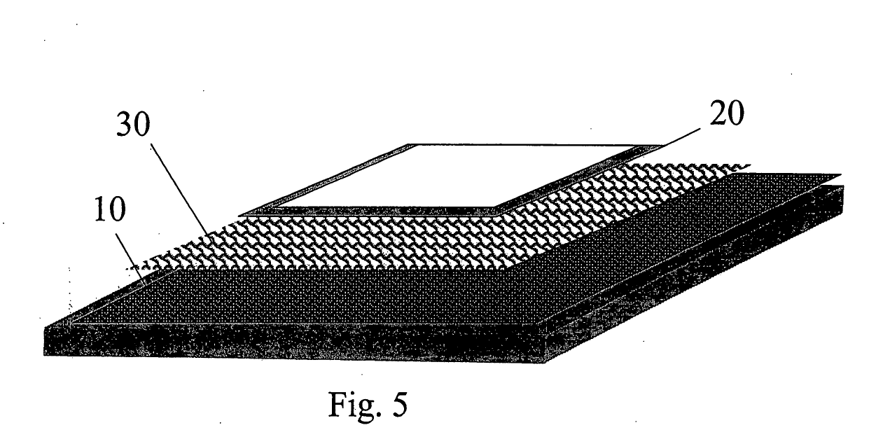

FIG. 5 shows another embodiment of the inventive method for producing a structurally integrated antenna. The starting material of the carrier system primary structure 10 consists here of a dry fiber semifinished product of a nonconducting fiber material (e.g., a glass fiber material). Due to the nonconducting properties of the fiber material, an insulation layer is not necessary in this embodiment. The antenna element 20 is applied directly to the carrier system primary structure 10 by means of a fixation layer 30, e.g., a thermoplastic film.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Method for producing a structurally integrated antenna in a fiber composite carrier structure of a vehicle, said method comprising:
arranging an antenna preform on a carrier system primary structure which is the form of a fibrous semifinished product, whereby the antenna preform is arranged in a layer comprising at least one flexible conductive antenna element; and
curing the component by at least one of temperature and pressure treatment.

2. The method as claimed in claim 1, wherein the flexible antenna elements are in the form of wire, strips or strand.

3. The method as claimed in claim 1, wherein the antenna preform is sewn or knitted onto the carrier system primary structure.

4. The method as claimed in claim 1, wherein the antenna preform is glued onto the carrier system primary structure by one of a thermoplastic layer and a resin.

5. The method as claimed in claim 1, wherein the carrier system primary structure comprises a dry fibrous semifinished product.

6. The method as claimed in claim 5, wherein before curing it, the component is impregnated with a curable resin.

7. The method as claimed in claim 1, wherein the carrier system primary structure comprises a semifinished prepreg.

8. The method as claimed in claim 1, wherein an insulation layer for electric insulation of the electrically conducting elements of the antenna preform of the carrier system primary structure is provided, such that either the insulation layer is part of the antenna preform or the insulation layer is applied to the carrier system primary structure prior to applying the antenna preform.

9. The method as claimed in claim 8, wherein the insulation layer is in the form of a dry fibrous semifinished product or semifinished prepreg.

10. The method as claimed in claim 1, wherein a nonconducting top layer is provided as an outer closure, and is part of or applied to the antenna preform after applying the antenna preform.

11. Method as claimed in claim 10, wherein the top layer is in the form of one of a dry fibrous semifinished product and a semifinished prepreg.

12. A structurally integrated antenna in a fiber composite carrier structure of a vehicle produced by introducing the flexible conducting antenna element(s) arranged in a layer during the production of the carrier structure.
